(19) United States
(12) Patent Application Publication
(10) Pub. No.: US 2007/0240210 A1
(43) Pub. Date: Oct. 11, 2007

(54) Method for controlling the access operations to resources in a computer system

(76) Inventors: Karlheinz Dorn, Kalchreuth (DE); Hans-Martin Von Stockhausen, Erlangen (DE)

Correspondence Address: HARNESS, DICKEY & PIERCE, P.L.C., P.O.BOX 8910, RESTON, VA, 20195, US

(21) Appl. No.: 11/710,412

(22) Filed: Feb. 26, 2007

(30) Foreign Application Priority Data
Mar. 27, 2006 (DE) 10 2006 014 019.2

(51) Int. Cl. G06F 9/46

(52) U.S. Cl. 726/16

(57) ABSTRACT

A method is disclosed for controlling the access to resources in a computer system with at least two access processes, where one access process accesses the resources of the respective other access process. An apparatus for carrying out the method and a computer program product with the method are also disclosed. In at least one embodiment, the call for a component as a resource of a thread as a first access process is diverted, following the call for a second resource of a second thread as a second access process, back to the first thread by a return call. This ensures that only one particular access process ever accesses the component and it is therefore not necessary to implement synchronization of the access processes to shared resources. The return call to the first thread affects the appropriate access to program areas which are actually encapsulated independently, with the access operations no longer needing to be synchronized by the program developer.

### PRIORITY STATEMENT

The present application hereby claims priority under 35 U.S.C. §119 on German patent application number DE 10 2006 014 019.2 filed Mar. 27, 2006, the entire contents of which is hereby incorporated herein by reference.

### FIELD

Embodiments of the invention generally relate to a method for controlling the access operations to resources in a computer system. For example, it may relate to one including at least two access processes with respective access to resources, where one access process accesses the resources of the other access process. Embodiments of the invention also generally relate to an apparatus for carrying out the inventive method and/or to a computer program product with the inventive method.

### BACKGROUND

Writing a computer program makes great demands on the program developer, since almost all the computer programs currently written need to have provision for interactions with other programs, databases or appliances via a multiplicity of interfaces. In addition to designing the software architecture on which the computer program is based, programming the computer program in appropriate software development environments is the principal work of a program developer. These software development environments, such as the Java development environment Eclipse, provide a multiplicity of tried-and-tested program development tools, such as generally used variable definitions for frequently used variables or specific program environments for testing program execution cycles. A program developer's program development work is supported by these development environments for a long time.

Particularly for object-oriented programming, the complexity of the associated organization and interaction of classes to be defined, objects and methods for the program execution cycles means that program development is possible only within the context of a development environment. In addition, the program modules being executed need to be monitored and controlled.

Particularly in the case of parallel processing of program execution cycles, allocation of the resources (processor resources, data or storage capacities) involves initiation, monitoring and control using what are known as processes and threads. In this case, processes have their own resources (e.g. their own variables) entirely. By contrast, threads use the resources within a process together, with all the threads from a process being taken into account independently of one another when the processor resources are provided.

Particularly in the case of image processing, e.g. in the case of the continual capture of medical image data and the subsequent image calculation during computer tomography (CT), threads are used to coordinate the processing steps which are to be performed in parallel by the computer program, e.g. visual display and simultaneous data input. Thus, animations or queries can be implemented in continuous loops without blocking all resources for further processing steps. This advantage of the use of threads has a considerable amount of associated synchronization complexity for the thread processing, however, since the threads access data simultaneously and hence data inconsistencies may arise. In this context, the program developer needs to ensure that not only is the allocation of the resources for the processes and threads carried out and monitored, but also the synchronization of the access operations and the associated communication between the threads are clearly defined.

When a plurality of threads are accessing the same data in a program environment, it is difficult to prove that the access involves access to valid data and not to interim results for other threads. These processing inconsistencies can arise because the operating system can interrupt each thread and can allow another thread to operate. If the interrupted thread is accessing data unprotected and the second thread accesses the same data record, incomplete interim results are sometimes accessed by the first thread, which implies a data inconsistency. It is therefore important to protect the data access operations.

Clever data protection does not protect everything, which destroys the parallelism and means sequential execution, but rather only the areas which are actually exposed to the competitive access, in order to ensure the greatest possible parallelism while at the same time having data protection. However, it is no small matter to find the compromise between full protection, where although everything is protected there is no parallelism, and the protection which is actually necessary, where only the software areas which are seen by a plurality of threads are protected, and therefore the greatest possible parallelism is permitted. A program developer developing a user interface application with a plurality of threads has always had to concern himself very intensively with synchronizing the access operations to his data, because user interface frameworks normally provide no inbuilt thread safety. These processes need to be observed particularly in the case of multiprocessor applications.

Some program environments, such as in the case of Java, therefore provide very complicated and complex methods for synchronizing the threads and the associated resource use and/or resource processing. To synchronize concurrent processes and threads, Java provides the concept of the “monitor”. The basic idea of this monitor is to combine the data on which the critical sections are working and the critical sections themselves in a central construct and to monitor it. A monitor is the encapsulation of a critical area—that is to say of a program part which can be processed only by one respective thread after an authorized call—using an automatically managed block. This block is set when the monitor is entered by a thread and is removed again when the monitor is left. If there is already another thread present upon entry into the monitor, the “entering” thread needs to wait until the competing thread has released the block and has left the monitor. The monitor concept is implemented using the keyword “synchronized” which has been integrated into the language.

However, one problem with the use of a monitor is that only single critical program sections can be blocked for the purpose of reciprocal exclusion of the thread calls. Coordination and synchronization of the thread access operations to a program section is not really possible and requires a high level of ability and experience from the program developer. To control and synchronize a plurality of threads for monitor access, Boolean variables are frequently used. Using this method, Boolean variables are altered only after the execution of a first thread, with subsequent threads being able to be called only when the relevant associated variables have been set by the previous thread as a call condition. This requires that the program developer have a high level of experience of handling multithread applications and the associated coordination of the thread calls.

Thus, US 2001/0027464 A1 describes an abstraction interface for transferring a firmware update to a broadband receiver. Similarly, DE 102 97 275 T5 discloses flexible acceleration of the Java thread synchronization on multiprocess computers.

### SUMMARY

To this end, a monitor is provided for regulating the access operations to a jointly used operating device by competing threads in line with at least one embodiment of the invention therein, where the monitor has a data structure for processing locking requests. Similarly, an extension is provided in the monitor data structure for the purpose of managing a count for explicit thread access operations in a given time period. A number of explicit requests for a given locking by competing threads is then counted and a count is recorded, with the count indicating the number of competing threads in a given time period. However, a drawback of the prior art is that the program developer needs to configure the synchronization of the accessing threads and their internal communication with one another independently too.

In at least one embodiment of the present invention, to a system is provided which avoids the aforementioned drawbacks in the prior art and assists a program developer in the implementation of multithread and/or multiprocess applications, particularly in the synchronization of a plurality of processes and threads, which may be dependent on one another, in a program development environment.

In line with at least one embodiment of the invention, the access to at least one resource of a first access process involves subsequent initiation of access to at least one resource of a second access process, and a return call diverts the access to the resource of the second access process to the resource of the first access process, with the first access process then controlling the access again.

At least one embodiment of the inventive method ensures that, on account of the return call by the resource of the second access process to the resource of the first access process, the second access process does not regulate the access, but rather always and exclusively the calling first access process. Thus, the program developer does not require any synchronization complexity for the access by competing access processes to a resource, since the access to a particular resource is always effected by one particular access process. Encapsulation of program and/or data areas for synchronous access to the resources is therefore not required.

Within the context of at least one embodiment of the invention, an access process is a process with a plurality of threads or at least one thread from a process. The thread can call at least one resource, such as a component, with any access to a resource always being affected by way of a particular thread. The return call by the second component to the first component using the second access process means that the access to both resources is only ever controlled by the first calling access process, so that there is no need to provide any monitoring and synchronization of any other access processes starting in connection with the access to the resources.

Within the context of at least one embodiment of the present invention, a resource is an object, a class, a method, a component or a data collection. In one advantageous refinement of at least one embodiment of the method, the resources of the second access process are passive and independently have no direct access to the resources of the first access process. Similarly, the called second access process is passive and independently has no access to the first access process.

Acknowledgement to the first access process is possible only by way of the second resource initiating a return call to the first component. In line with at least one embodiment of the invention, the return call is initiated by an appropriate operational unit upon the request of the second resource and monitors the association with the first calling access process.

The first access process is advantageously executed at a higher program level than the second access process, and following the access by the resource of the first access process to the resource of the second access process, the return call is made to the higher program level. This allows cascaded concatenation of the access operations by a first component to a respective second component without this requiring the program developer to synchronize the associated access and communication processes and to coordinate them in terms of execution. The calls for resources from different program levels via a respective first access process are made to the respective hierarchically lower second access process, and the respective return calls by the respective second access processes are sent to the respective first access process on the respective next highest program level. The return calls are advantageously evaluated on the respective next highest program level. The return calls are therefore made in the opposite order to the call order of the calling resources within the respective first access processes.

In one advantageous refinement of at least one embodiment of the method, provision is made for the content of a resource to be able to be changed during the program execution. In the case of a passive resource, the resource, e.g. a component or a data record, can be changed during the program execution without this requiring a program interruption. The resources can therefore be changed dynamically, with the content of a plurality of resources being implemented as respective presentation objects in an interface. Using the representation of a resource as a respective presentation object, it is possible to implement a change in the resource on an interface.

In line with at least one embodiment of the invention, the contents of a plurality of resources in a plurality of interfaces are changed as part of a superordinate change of strategy. The change in the contents, such as the presentation objects, is not made for each interface individually, but rather the change is made for all relevant interfaces during the runtime of the program as part of a prescribed strategy. This in turn ensures that the alternation of the presentation objects does not give rise to any inconsistencies between the resource calls and the underlying access processes.

Synchronization of the resource and data access operations therefore does not need to be considered by the program developer, since incorrect execution cycles are avoided through coordinated association of the access operations and corresponding return calls by all relevant resources and/or access processes. In line with at least one embodiment of the invention, the change in the contents of all the resources in one interface can be stored centrally in a memory and loaded into the interface, the memory content being able to be transferred to the interface independently of the access processes. The initiation of a change of strategy for all relevant presentation objects can therefore be prescribed for all presentation objects externally for the relevant interfaces and is thus not dependent on the access and return call processes of the running program. The transfer of all memory contents therefore takes place centrally for an interface and can be controlled in coordinated fashion.

At least one embodiment of the invention provides an apparatus for controlling at least two access processes to resources in a computer system, where an operational unit is used to control and monitor the access processes, and the access to at least one resource of the first access process can involve subsequent initiation of access to at least one resource of the second access process, and a return call by the operational unit diverts the access to the resource of the second access process to the resource of the first access process, so that the access is effected by the first access process.

In one advantageous refinement of the apparatus, the resource of the second access process can be stored passively in a memory, and the second execution unit does not independently initiate a return call to the resource of the first access process on the first execution unit via the operational unit on the basis of the second access process which is being executed. The return call to the resource of the first access process can be initiated only by a resource of the second access process, which is executed in the second execution unit.

Advantageously, a respective operational unit controls the calls for resources from different program levels via a respective first access process on a respective first execution unit to the second access process on a next lowest program level on a respective second execution unit. At the same time, the respective second execution units generate the respective return calls from the respective second access processes and transmit them to the respective first access process on the respective first execution units on the respective next highest program level. The return calls are transmitted using conventional connections and interfaces between the execution units.

In one example embodiment of the inventive apparatus, an operational unit coordinates all return calls to resources from different program levels. The combination of the return calls in an operational unit allows the operational unit to make a rapid and simple association between the respectively called second resources and a respective access process for a first resource. At the same time, this allows the current and probable return calls to be logged. Thus, the association of the return calls to the respective first resource and the associated respective first access process are able to be ensured with a high degree of reliability by the operational unit.

In an interface, at least one embodiment of the invention allows the content of a plurality of resources to be implemented as respective presentation objects. A strategy unit controls the change in the presentation objects centrally in a plurality of interfaces. During the runtime of the program, the strategy unit is therefore used to ensure—either on the basis of the program state or in freely selectable fashion—that the presentation objects in the interfaces can be changed simultaneously and in coordinated fashion. Synchronization of the access operations to the resources and/or of the access processes by the program developer is not necessary with the inventive apparatus for access by different access processes to shared resources.

At least one embodiment of the invention provides a computer program product which includes a computer-readable medium with program instructions which can be executed by a computer and which are designed to control the access to resources in a computer system with at least two access processes, where one access process accesses the resources of the respective other access process, with the access to at least one resource of a first access process involving subsequent initiation of access to at least one resource of a second access process, and a return call diverting the access to the resource of the second access process to the resource of the first access process in the first access process.

### BRIEF DESCRIPTION OF THE DRAWINGS

Embodiments of the invention are described in more detail with reference to example embodiments and the figures which follow, in which:

FIG. 1 shows an illustration of the threading model based on the prior art;

FIG. 2 shows an illustration of an embodiment of the inventive threading model;

FIG. 3 shows a concept illustration of the structure of an embodiment of the inventive method;

FIG. 4 shows a UML illustration of an embodiment of the inventive method flow for asynchronous access by a thread;

FIG. 5 shows an illustration of a cascaded access process with different program levels.

In the figures, features having the same sense have been provided with the same reference symbols.

### DETAILED DESCRIPTION OF THE EXAMPLE EMBODIMENTS

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

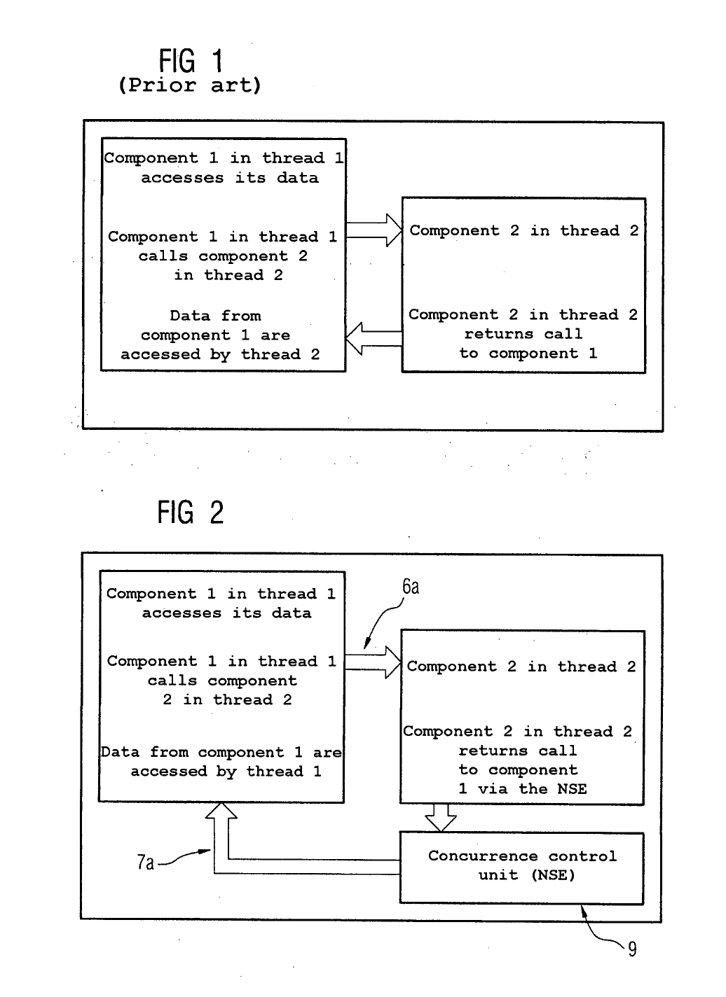

FIG. 1 shows a threading model based on the prior art. A thread as a first access process contains a first component 1 as a resource of the first access process. The first component 1 accesses shared data, that is to say an area in which the access to the data needs to be synchronized. The first component 1 accesses a second component 2 as a resource of a second access process in the form of a second thread. For the purpose of processing the data, the threads need to be synchronized.

Following conclusion of the access to the component 2 in the second thread, the component 2 now returns a call to the component 1 in the first thread. The second component 2 is terminated when the first component is called. A drawback of this is that the second thread now controls and monitors the access by the first component 1 to the data as the now calling thread. This threading model necessitates that the access processes be synchronized and that the respective call for resources be organized between the threads and to some extent be prescribed manually.

By way of example, the threads are synchronized in the prior art using Boolean variables or counters, with the first thread having the exclusive authorization to set the Boolean variables or counters for the first time. The subsequent threads cannot be executed until an appropriately set counter or a set Boolean variable has been provided. The organization of the respective dependencies among the threads by setting the variables and counters needs to be carried out and manually implemented by the program developer himself.

FIG. 2 shows a threading model based on an embodiment of the invention. Unlike in the prior art, an operational unit 9 initiates a return call 7a from a called component back to the calling component. Conventionally, the return call from the called component to the component of the calling thread is generated as a first access process. In this case, however, the calling second thread then accesses the first component 1 (see FIG. 1). By contrast, the use of an operational unit 9, which is in the form of what is known as a concurrence control unit (NSE) in the example embodiment, allows maybe a plurality of return calls 7a, 7b, 7c to be associated with a respective previously calling access operation 6a, 6b, 6c and allows initiation of a return call 7a, 7b, 7c to the respective calling thread, in FIG. 2 thread 1.

The use of the operational unit 9 makes it possible to connect return calls 7a, 7b, 7c from various threads back into the respective calling thread by way of the initiated access operations 6a, 6b, 6c. This actually encapsulates an area worth protecting and protects it from competing access operations and access processes. In comparison with encapsulation by a monitor, where, despite the stipulation of an area worth protecting, the program developer needs to ensure how the access processes and the calls for the resources need to be synchronized, an embodiment of the inventive method relieves the program developer of this task and means that he does not need to take into account any association between the access processes and their possibly existing dependency.

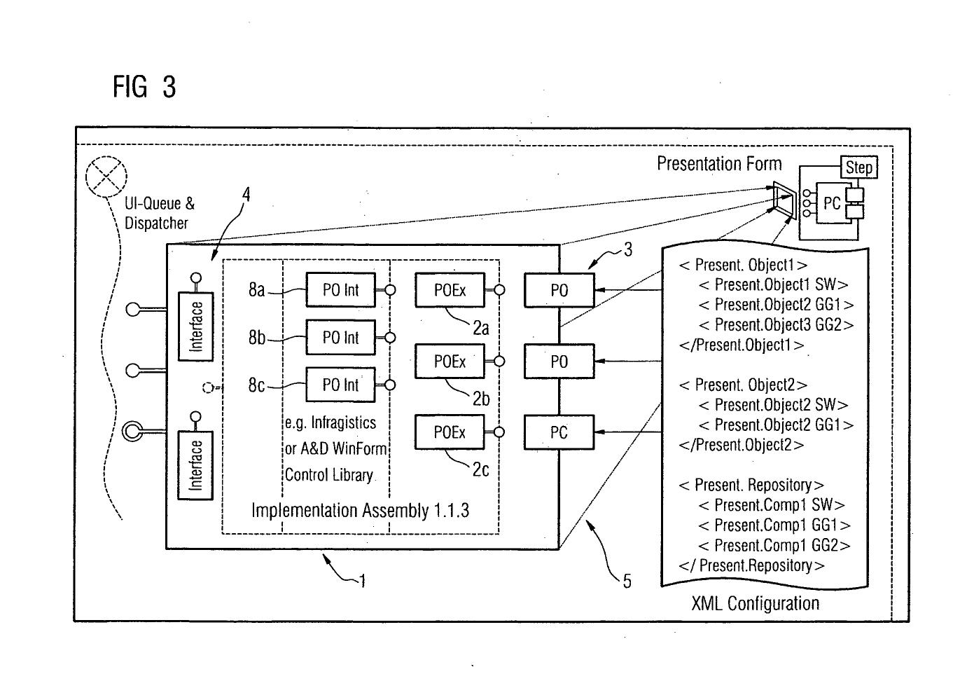

FIG. 3 shows a concept illustration of the structure of an embodiment of the inventive method with fundamental structural features. The chip 1 on a program level has an interface 4. At the same time, the presentation objects 2a, 2b, 2c within the chip 1 are processed as internal processes 8a, 8b, 8c. The presentation objects 2a, 2b, 2c are passive and can be changed using a service repository 3, 5.

The program developer uses a wizard to generate the code for the interface 4, the presentation objects 2a, 2b, 2c with their interfaces 8a, 8b, 8c, and a service repository with the presentation component 5, which are required for use. In addition, a thread for the asynchronous calls may be generated. Furthermore, a configuration file is produced. The actual logic can then be programmed in the generated bodies 3 of the presentation objects 2a, 2b, 2c.

The interface 4 of the chip 1 is preferably organized such that it comprises methods and properties. In this context, the methods may be synchronous and/or asynchronous. Similarly, stipulations are possible which prescribe the further action in the case of asynchronous calls, such as progress events and cancel methods. These specifications allow asynchronous calls to be terminated or their progress observed.

A strategy for the presentation objects 2a, 2b, 2c may be available in various versions. To load a particular version of a presentation component 5, its version needs to be specified in addition to the assembly name in the configuration. Furthermore, an interface 4 of a presentation component 5 in one version always needs to support all the previous versions of the interface 4. An interface 4 of a presentation component 5 may only ever be extended and never broken. In addition, the instantiation strategy works in a manner such that when a plurality of presentation components 5 are being configured it is always the latest version of an interface 4 which is instantiated. The presentation component 5, which requires an earlier version of the interface 4, is also satisfied by a later interface 4. This strategy can be turned off so that, if required, it is also possible to instantiate an old presentation component 5.

An embodiment of the inventive method visibly provides an external interface with a logical object model which is implemented using the available external interface. The reason for this requirement is the isolation between the external interface and the implementation of the chip 1 with the intention of making the client of the chip 1 independent of its implementation. If only the collection of the external interfaces were visible as “external” interface for the chip 1, the implementation of the chip 1 could not change without breaking the connection to its clients, which in this case find a changed implementation.

Typically, only one implementation is called at the same time in an interface 4. The strategy is intended precisely for selecting a suitable implementation. In certain cases, it is also possible to call all or a subset of all the implementations sequentially, but only one should ever be active at the same time. Both of the aforementioned variants are possible, but the sequentialization means that there can be no danger.

The presentation objects 2a, 2b, 2c can be replaced by means of a change. A configuration file in XML format is shown by way of example below. A program “Calculator” with three presentation objects “Add”, “Sub” and “Div” is defined. Only the interface “Add” is preset to be visible externally.

//-------------------------------------------------------------
//Start of XML configuration file for the presentation
component
//-------------------------------------------------------------
<?xml version=“1.0” encoding=“us-ascii”?>
<PRESENTATION-OBJECTS>
<PRESENTATION-OBJECT LOGID=“NCalc.Prov_Add”
TYPE=“NCalc.Prov_Add”
ASSEMBLY=“Prov_Add.dll”>
<INTERFACES>
<INTERFACE TYPE=“NCalc.Prov_Add_IF” />
</INTERFACES>
<PROPERTIES>
<USER-DATA KEY=“ProviderId” VALUE=“a_ProviderId_0” />
</PROPERTIES>
</PRESENTATION-OBJECT>
<PRESENTATION-OBJECT LOGID=“NCalc.Prov_Sub”
TYPE=“NCalc.Prov_Sub”
ASSEMBLY=“Prov_Sub.dll”>
<INTERFACES>
<INTERFACE TYPE=“NCalc.Prov_Sub_IF” />
</INTERFACES>
<PROPERTIES>
<USER-DATA KEY=“ProviderId” VALUE=“a_ProviderId_O” />
</PROPERTIES>
</PRESENTATION-OBJECT>
< PRESENTATION-OBJECT LOGID=“NCalc.Prov_Div”
TYPE=“NCalc.Prov_Div”
ASSEMBLY=“Prov_Div.dll”>
<INTERFACES>
<INTERFACE TYPE=“NCalc.Prov_Div_IF” />
</INTERFACES>
<PROPERTIES>
<USER-DATA KEY=“ProviderId” VALUE=“a_providerId_O” />
</PROPERTIES>
</PRESENTATION-OBJECT>
</PRESENTATION-OBJECTS>
//-------------------------------------------------------------
//End of XML configuration file for the presentation component
//-------------------------------------------------------------

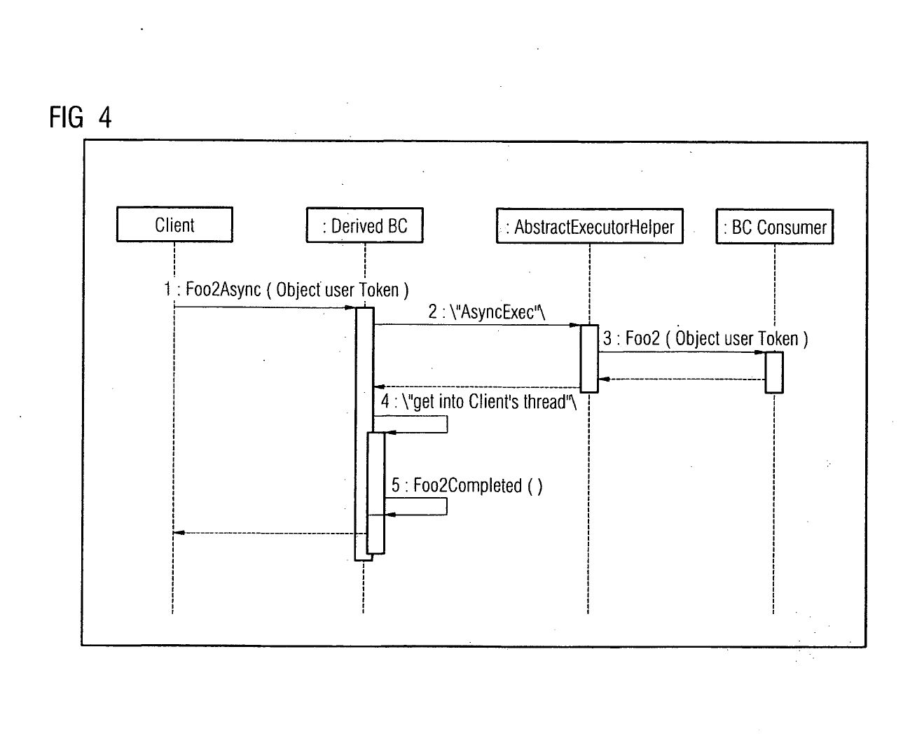

FIG. 4 shows a Unified Modeling Language (UML) diagram for an embodiment of the inventive method flow with an asynchronous call. In this case, a presentation object (on the right) is being called asynchronously. What is important here is that the presentation object is always called by the same thread. The return call can therefore always be associated with the calling thread directly and hence the access to the resources can be regulated.

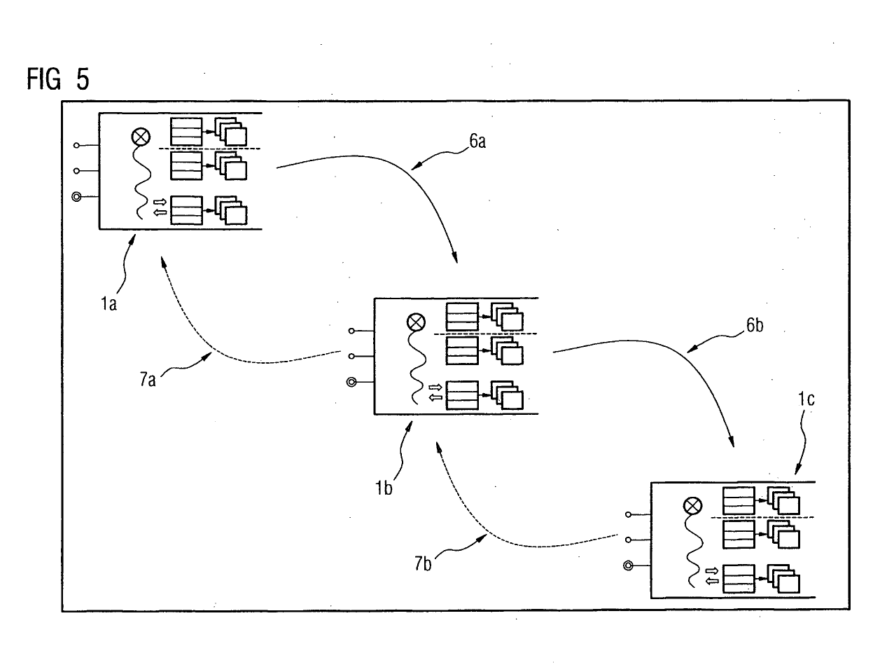

FIG. 5 shows a cascaded asynchronous call for a first chip 1a in respective other chips 1b, 1c. Following a call for a component in a first chip 1a, the component, as a first resource for an original thread (not shown), accesses a second component on a lower program level 1b. The original thread is executed in the first chip 1a. The component within the chip 1b on the second program level is access by the component on the first program level la by initiating a thread 6a as access operation. The thread 6a is logged in the operational unit 9 (not shown). The component thus called within the chip 1b on the second program level continues to call a component within the chip 1c on the lower third program level, with the call again being logged in the operational unit 9.

Following conclusion of the access to the component within the chip 1c on the third program level, the operational unit 9 calls the component within the chip 1b on the second program level, with the return call 7b being connected to the corresponding call 6a and being processed within the chip 1 on the higher program level. Following conclusion of the access to the component within the chip 1b on the middle program level, the component within the chip 1a on the first program level is accessed by means of a return call 7a by the operational unit 9, this return call 7a pointing to the access thread 6a. Re-entry into the original thread occurs in serialized fashion, i.e. the return calls 7a, 7b, 7c are delivered to the original thread in the order in which they are requested from the operational unit 9.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for controlling the access to resources in a computer system with at least two access processes, the method comprising:
accessing, via a first access process, resources of a respective second of the at least two access processes; and
accessing at least one resource of the first access process, the accessing at least one resource of the first access process involving subsequent initiation of access to at least one resource of the second access process, a return call diverting the access to the resource of the second access process to the resource of the first access process.

2. The method as claimed in claim 1, wherein a thread is an access process, and at least one resource is callable within the thread, with any access to a resource always being initiated within a particular access process.

3. The method as claimed in claim 1, wherein a resource is at least one of an object, a class, a method, a component and a data collection.

4. The method as claimed in claim 1, wherein the resource of the second access process is passive and independently has no access to the resource of the first access process.

5. The method as claimed in claim 1, wherein the called second access process is passive and cannot independently initiate a return call to the first access process.

6. The method as claimed in claim 1, wherein the first access process is executed at a relatively higher program level than the second access process, and following the access by the resource of the first access process to the resource of the second access process, the return call is made to the relatively higher program level.

7. The method as claimed in claim 6, wherein the access operations from different program levels via a respective first access process are effected to the respective hierarchically relatively lower second access process, and the respective return calls by the respective second access processes are made to the respective first access process on the respective next relatively highest program level.

8. The method as claimed in claim 1, wherein the content of a resource is changeable during the program execution.

9. The method as claimed in claim 8, wherein the content of a plurality of resources is implemented as respective presentation objects in an interface.

10. The method as claimed in claim 8, wherein the content of a plurality of resources is alterable by changing the respective presentation objects in an interface.

11. The method as claimed in claim 8, wherein the contents of the resources in a plurality of interfaces are changed as part of a change of strategy.

12. The method as claimed in claim 8, wherein the change in the contents of all the resources in one interface is storable centrally in a memory and loaded into the interface, the memory content being transferable to the interface independently of the access processes.

13. The method as claimed in claim 8, wherein the transfer of all the memory contents for an interface is controllable centrally and in coordinated fashion.

14. The method as claimed in claim 1, wherein at least one of the access to a second component and the return call to a first component are affected by way of a respective separate access process.

15. An apparatus for controlling the access to resources in a computer system with at least two access processes, where a first access process accesses the resources of the respective second access process, with a first execution unit for the execution of the first access process and with a second execution unit for the execution of the second access process, the apparatus comprising:
an operational unit to control and monitor operations of the accesses, with the access to at least one resource of the first access process being able to involve subsequent initiation of access to at least one resource of the second access process, and a return call from the operational unit diverting the access to the resource of the second access process to the resource of the first access process.

16. The apparatus as claimed in claim 15, wherein the resource of the second access process is storable passively in a memory, and the second execution unit does not independently have a return call to the resource of the first access process on the first execution unit via the operational unit on the basis of the second access process which is being executed.

17. The apparatus as claimed in claim 15, wherein a respective operational unit controls the access operations for resources from different program levels via a respective first access process within a first chip to the second access process within a chip on a relatively lower program level and performs the respective return calls from the respective second access processes to the respective first access process on the respective relatively next highest program level.

18. The apparatus as claimed in claim 17, wherein the operational unit coordinates all access operations and return calls to resources from different program levels.

19. The apparatus as claimed in claim 15, wherein the content of at least one resource is implementable as a presentation object in an interface.

20. The apparatus as claimed in claim 15, wherein a strategy unit controls the change of the presentation object in a plurality of interfaces centrally.

21. A computer program product, comprising a computer-readable medium including program instructions which, when executed by a computer, control access to resources in a computer system with at least two access processes, wherein a first access process accesses the resources of the respective second access process, with the access to at least one resource of the first access process involving subsequent initiation of access to at least one resource of the second access process, and a return call diverts the access to the resource of the second access process to the resource of the first access process.

22. A computer program product comprising a computer-readable medium including program instructions which, when executed by a computer, permit execution of the method as claimed in claim 1.

23. The method as claimed in claim 2, wherein a resource is at least one of an object, a class, a method, a component and a data collection.

24. The apparatus as claimed in claim 16, wherein a respective operational unit controls the access operations for resources from different program levels via a respective first access process within a first chip to the second access process within a chip on a relatively lower program level and performs the respective return calls from the respective second access processes to the respective first access process on the respective relatively next highest program level.

25. A computer readable medium including program segments for, when executed on a computer device, causing the computer device to implement the method of claim 1.
